(19) United States
(12) Patent Application Publication
(10) Pub. No.: US 2007/0120755 A1
(43) Pub. Date: May 31, 2007

(54) Roof antenna for mounting on a vehicle roof with a central fastener between an outer cover and an intermediate cover

(75) Inventor: Gunther Blickle, Walddorfhaeslach (DE)

Correspondence Address: THE FIRM OF KARL F ROSS, 5676 RIVERDALE AVENUE, PO BOX 900, RIVERDALE (BRONX), NY, 10471-0900, US

(73) Assignee: HIRSCHMANN CAR COMMUNICATION GMBH

(21) Appl. No.: 11/584,349

(22) Filed: Oct. 20, 2006

(30) Foreign Application Priority Data
Oct. 20, 2005 (DE) 102005050748.4

(51) Int. Cl. H01Q 1/32

(52) U.S. Cl. 343/713; 343/872

(57) ABSTRACT

The invention relates to a roof antenna (1) for installation on the roof (2) of a vehicle, the roof antenna (1) comprising a base plate (3) with at least one antenna element (5 to 8) and an outer cover (9) for covering the interior region of the roof antenna (1) covered by an intermediate cover (8) and the base plate, (3) being connected to the vehicle roof (2) with fastener, there being according to the invention in the region of the contact area of the outer lower edge of the outer cover (9) a seal (12) is mounted and fastener (B) are mounted in a central location, which means detachably fasten the outer cover (9) to the intermediate cover (8), the sealing effect of the seal (12) being achieved after securing the outer cover (9) to the intermediate cover (8) using the fastener (B).

The invention relates to a roof antenna for installation on the roof of a vehicle according to the characteristics of the preamble of claim 1.

Roof antennas for installation on the roofs of vehicles are known in principle. Roof antennas of this type comprise a base plate that is secured to the vehicle roof with a fastener. The base plate is provided with antenna elements for different frequency ranges, these antenna elements being mounted on a circuit board that in turn is fastened to the base plate. So as to protect the antenna elements when transporting the preassembled roof antenna and, during installation on the vehicle roof, an intermediate cover (also referred to as protective cover) is provided that is fastened to the base plate. After this preassembled unit, which is typically produced by the antenna manufacturer and supplied to the vehicle manufacturer, has been mounted on the vehicle roof, a further outer cover is installed, which is also referred to as an exterior cover or decor cover. This outer cover is intended to take the vehicle decor into consideration in terms of the exterior shape, surface structure and color, and to protect the installed roof antenna from exterior influences, particular the influences of mechanical or other factors (such as water or the like). Arrangements of this type in principle are aimed not only at allowing quick and simple installation of a roof antenna, but also at meeting the requirements in terms of durability and stability.

A first solution that has been disclosed is to provide the base plate with the intermediate cover following the installation of the antenna elements and fasten this preassembled unit to the vehicle roof. Thereafter, the outer cover is placed over this assembly and glued to the vehicle roof at its lower outer edge. Problems, however, arise particularly from the shape tolerances of the vehicle body as well as from the difficult assembly, since a glue connection always requires a certain amount of time until it is completely cured and during this time pressure must be applied manually or with complex devices and furthermore also requires complex preparation (cleaning) of the adhesive surface. Furthermore, after the glue connection has fully cured, it is no longer possible to adjust the position of the outer cover relative to the vehicle roof. In addition, disassembly is difficult when, for example, a damaged outer cover or an otherwise defective roof antenna has to be replaced. The glued outer covers furthermore require wide adhesive borders to ensure a reliable and tight glue connection and therefore they necessitate a large base surface.

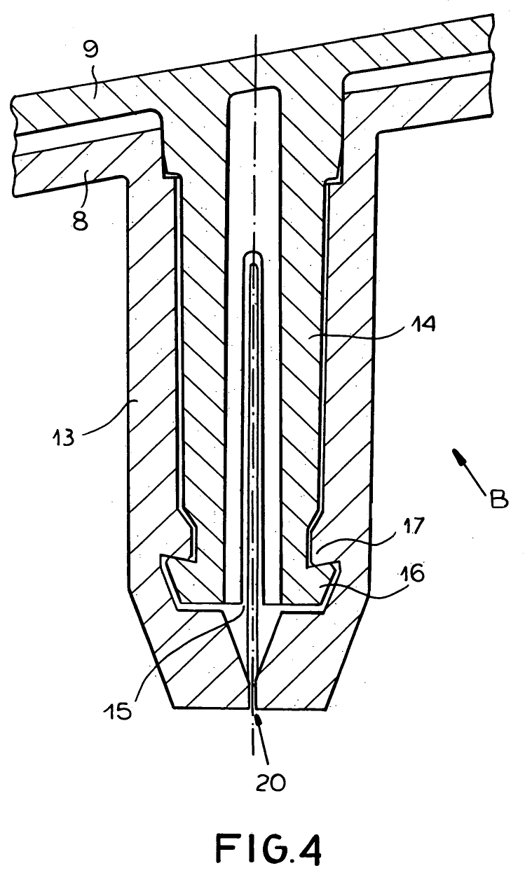

An outer cover for somewhat simpler installation is disclosed in DE 20 2004 004 740 U1. A base plate is provided with antenna elements, the base plate with the antenna elements being surrounded by an intermediate cover that is fastened to the base plate with a latch arrangement. The fastener of the outer cover to the intermediate cover in this patent comprises an open swivel joint and a spring hook that are mounted at opposite ends of the roof antenna. So as to be able to install the outer cover, the cover must be fitted in place at an angle and inserted into the open swivel joint, and then the outer cover is pivoted toward the direction of the vehicle roof so the spring hook is actuated and the outer cover rests against the intermediate cover in a latched position. In this solution, however, the glue connection of the lower outer edge of the outer cover to the vehicle roof is maintained (see FIG. 4, reference numeral 14 of DE 20 2004 004 740 U1).

It is therefore the object of the invention to improve a roof antenna comprising an intermediate cover and an outer cover such that the outer cover can be fastened quickly, easily and durably to the intermediate cover, that the connection is detachable and that a glue connection between the outer cover and the vehicle roof can be eliminated.

This object is achieved with the characteristics of claim 1.

According to the invention, in the region of the contact surface of the outer lower edge of the outer cover a seal is provided, with a fastener being provided on a central, meaning a single location, which fastener detachably secures the outer cover to the intermediate cover, and furthermore the sealing effect of the seal is achieved after the outer cover has been secured to the intermediate cover with the fastener. As a result, the present invention offers several advantages: Since the fastener is only provided in one central location, the entire design including the roof antenna elements is simpler, resulting in cost savings. In particular the tools used for producing the intermediate cover and the outer cover can be simplified, which covers are produced, for example, using a polymer injection-molding method. Furthermore, assembly is simpler because the fastener only has to be actuated in one central location or is directly actuated when placing the outer cover on the intermediate cover. A further essential advantage can be seen in that a glue connection between the outer cover and the vehicle roof is eliminated, since following the installation and securing of the outer cover to the vehicle roof a seal is provided in the region of the contact surface of the outer lower edge of the outer cover, the sealing effect of which seal is automatically achieved when the outer cover has assumed the target position on the intermediate cover using the fastener. This means that the seal is also effective when the outer cover is fastened to the intermediate cover by means of a preferred latch or screw connection, thus preventing the entry of water, dirt and similar undesirable substances through the gap between the outer cover and the vehicle body as well as into the space between the outer cover and intermediate cover.

The sealing effect is achieved in that a outer seal provided on the intermediate cover or on the base plate of the roof antenna rests against the outer cover, particularly on the outer lower edge thereof, and thus seals the outer cover relative to the vehicle roof and the intermediate cover, so that the interior of the roof antenna and the region between the covers is protected from outside influences. In a particularly advantageous embodiment, the seal has a sleeve-like configuration, thus achieving the sealing effect with low pressing forces when installing the outer cover.

The sealing effect can also be achieved in that the outer seal is provided directly on the outer cover and rests against the intermediate cover or a region of the base plate. Furthermore, the seal can be configured as a separate part that is installed following the mounting of the antenna on the vehicle body and prior to mounting the outer cover.

In addition to the sealing effect, the outer cover is guided and/or held in the horizontal directions with the lower edge as a result of the interaction between the seal, the intermediate cover and optionally the base plate. In conjunction with the central fastening of the outer cover, which also defines the vertical direction of the outer cover, this creates a reliable and stable attachment of the outer cover without play.

With respect to the configuration of the fastener for securing the outer cover to the intermediate cover, it is preferred if screw connections or snap-fit connections are used, however also other types of connections are conceivable, for example if the outer cover and the intermediate cover are made of plastic, a glue connection, a welded connection (for example by means of ultrasonic welding) or the like are possible in the region of the central fastening point, these connection techniques being considered second-best compared to a screw connection or a snap-fit connection.

Further embodiments of the invention are laid out in the dependent claims, which result in corresponding advantages. In addition to the concrete design of the outer cover and the intermediate cover in the region of the central fastening point, equivalent embodiments are also possible that achieve the same goal, namely the securing of the outer cover to the intermediate cover in a single central fastening point, using a different design.

Illustrated embodiments of the invention are described hereinafter and explained with reference to the figures, however the invention is not limited to these embodiments.

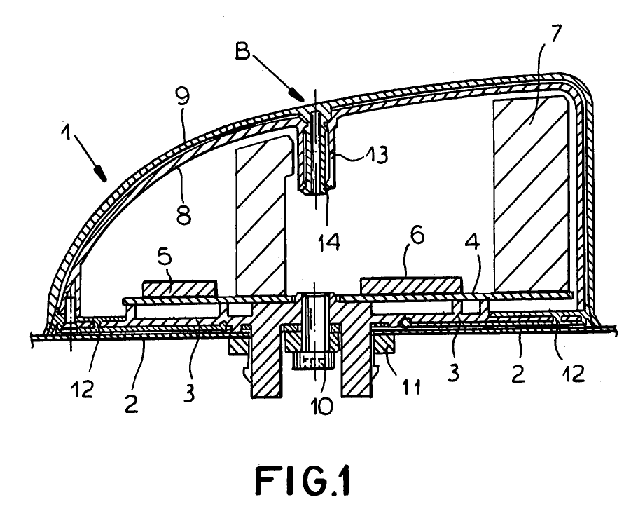

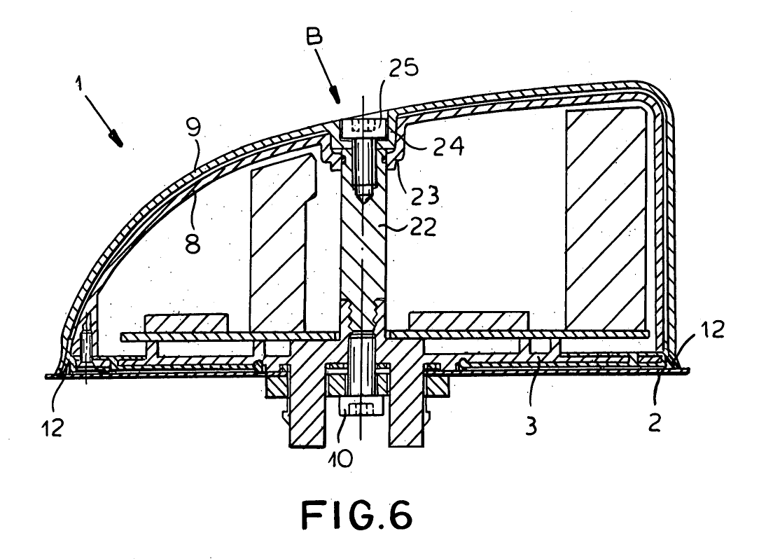

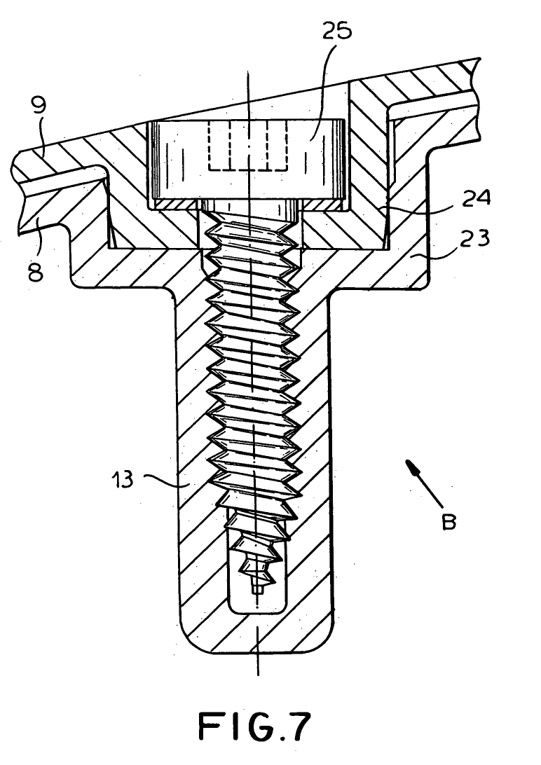

FIGS. 1 to 5 as well as FIGS. 6 and 7, to the extent that they are illustrated in detail, each show an embodiment of a roof antenna 1 according to the invention.

The embodiments may have the structure of the roof antenna 1 in common, however different structures are conceivable as well. The roof antenna 1 is installed on a vehicle roof 2 and comprises a base plate 3 on which a circuit board 4 is mounted and fastened, for example with screws. The circuit board 4 comprises at least one antenna element, particularly several antenna elements 5-7 for different frequency ranges. The intermediate cover 8 covers the region of the antenna elements 5 to 7 as well as of the circuit board 4 in the standard manner, the intermediate cover 8 being fastened to the base plate 3 by means of a snap-fit connection, a screw-connection or the like. A unit of this type is typically produced by an antenna manufacturer and supplied to a vehicle manufacturer for installation. Further elements of the roof antenna 1 that are required for the antenna to function (such as cables, plug connectors and the like) are provided, however they are not shown in the illustrated embodiments. Following installation of the preassembled unit on the vehicle roof 2, an outer cover 9 is attached over the intermediate cover 8 after the base plate, which has a downwardly directed collar, has been guided with this collar through a hole in the vehicle roof 2 and fastened to the vehicle roof 2 using a screw connection 10 and a clamping plate 11. Furthermore, a seal 12 is provided, which in this illustrated embodiment rests not only against the outer lower edge of the outer cover 9 following securing of the cover to the intermediate cover 8, but which is also located between the bottom face of the base plate 3 and the top face of the vehicle roof 2. This single seal 12 (it is also possible to provide several seals) both protects the interior of the roof antenna 1 from outside influences and prevents outside influences (particularly moisture or water) from penetrating into the interior of the vehicle via a hole in the vehicle roof 2, which hole is not described in detail. FIG. 1 illustrates and is intended to clarify that the effect of the seal 12 is achieved and is best when the outer cover 9 has been fixed in the desired position over the central fastening point B on the intermediate cover 8.

The only and also central fastening point B is formed by an inwardly directed locking pin 14, the locking pin 14 snapping into the seat 13 after insertion when the outer cover 9 has assumed the desired position relative to the intermediate cover 8 and upon actuation of the seal 12. This means that the dimensions of the seat 13 and the locking pin 14, particularly the lengths thereof, are selected such that the latching effect takes place when not only the outer cover 9 has reached the desired-position relative to the intermediate cover 8, but also when the sealing effect of the seal 12 is optimal. Instead of the seal 12, a deformation of the outer lower edge of the outer cover 9 can assume the sealing function, this edge being provided, for example, with a cross-sectional taper toward of the vehicle roof 2, so that the outer lower edge of the outer cover 9 can nestle against the surface of the vehicle roof 2. The fit of the outer lower edge can furthermore be improved when the outer cover is produced using a two-component injection-molding technique, this region being produced with a softer material than the remainder of the outer cover.

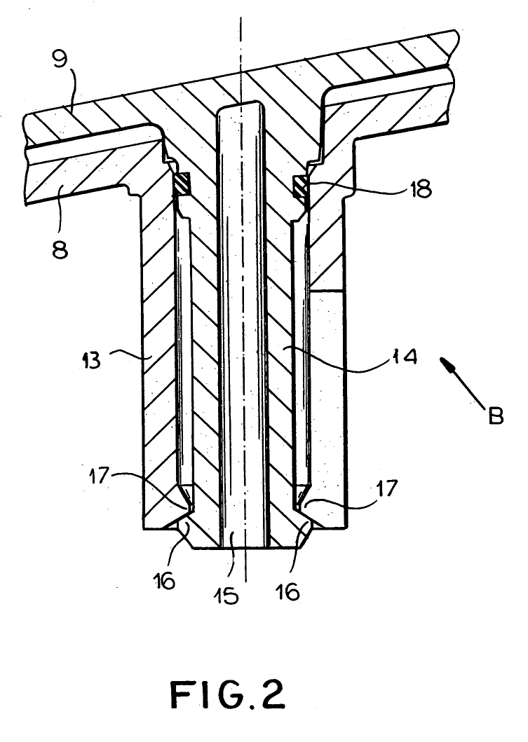

A concrete embodiment of the snap-fit connection of the central fastening point 8 is illustrated in FIG. 2. So as to achieve the latching effect, the locking pin 14 comprises an outwardly directed catch lug 16 at the end, this catch lug 16 corresponding to an inwardly directed catch lug 17 of the seat 13. So as to allow deformation of the catch lug 16 to a certain extent when passing the catch lug 17, an inner passage 15 is provided inside the locking pin 14. The outer cover 9 is therefore placed on the preassembled roof antenna 1 and pressed on in the vertical direction. Instead of the outer catch lugs 16 and 17, it is also possible to provide projections and/or recesses, which may also be provided in partial sections. This way, for example, the catch lug 16 can be maintained and the seat 13 may comprise a recess (groove) instead of the outwardly directly catch lug 17, which recess engages with the catch lug 16. The reverse arrangement of the tongue-and-groove principle is also conceivable. Finally, a seal 18 (for example an O-ring) is provided in the upper region of the seat 13 and/or of the locking pin 14 between the outer cover 9 and intermediate cover 8 in order to prevent entry of water or moisture into this location. The seal 18 may be provided, but does not have to be.

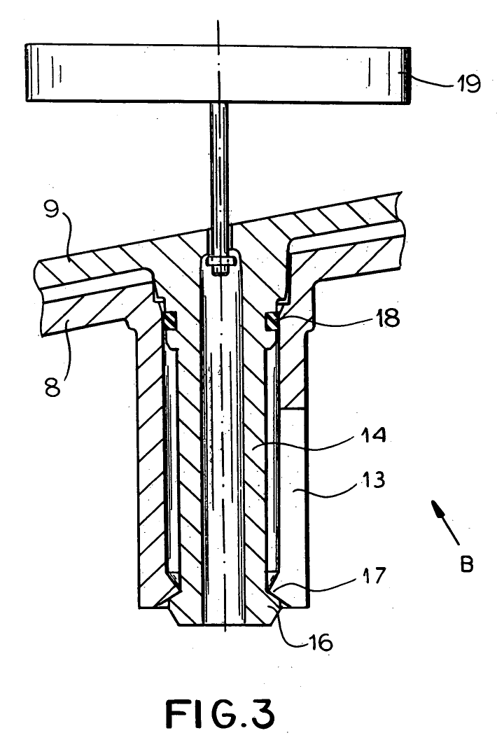

FIG. 3 shows the method for disassembling the outer cover 9. The outer cover 9 is provided with a small oblong hole in the region of the fastening point B, which configuration either forms the interior passage 15 or makes an inner passage 15 accessible if such a seat is provided. When the inner passage 15 becomes accessible, a pulling tool 19 can be inserted through it. The tool 19 is engaged beneath the wall of the outer cover 9 after a 90° rotation, and a pull on the tool 19 frees the outer cover 9 from the roof antenna 1, particularly from the intermediate cover 8, against the latching force of the latching formations 16 and 17. Following reinstallation, the outer cover 9 can be reclosed using a small plug and the bore site can be repaired with a touch-up applicator. As a result, the outer cover 9 can be reused if needed. In another advantageous embodiment, the pulling tool may be formed like a plastic screw at the lower end, this end being screwed into the plastic material of the outer cover to allow the cover to be pulled out of the latching connection.

FIG. 4 shows the configuration of mutually latching lugs 16 and 17, the latch geometry being configured such that disassembly simply by tensile force, as is the case in the embodiment according to FIG. 3, is no longer possible. This results in absolutely secure retention of the outer cover 9 on the roof antenna 1.

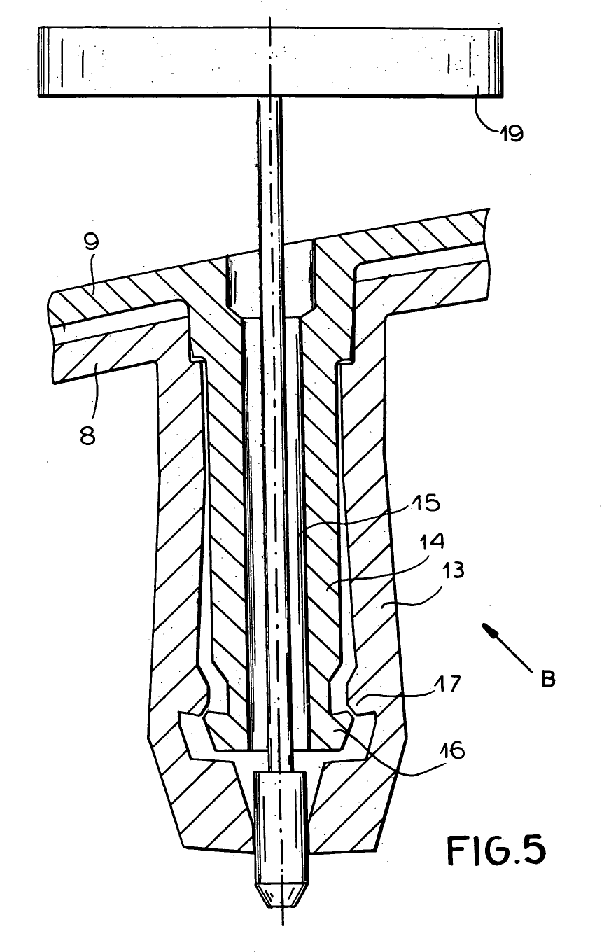

For disassembly, a special tool used to release the snap-fit connection 16, 17 is provided, this tool 19 comprising a thicker region at its end, which region is likewise guided through the interior passage 15 to the end region of the seat 13 of the intermediate cover 8, and the seat 13 in the end region is formed with a gap 20 that is expanded such that the catch lugs 16 and 17 lift off each other and the outer cover 9, or more precisely the locking pin 14 thereof, can be pulled out of the seat 13 (FIG. 5). For this purpose, the seat 13 may be provided with one or more vertical slots, which facilitate the opening of the seat by pressure.

FIGS. 6 and 7 show the fastening of the outer cover 9 using the central fastening point B on the intermediate cover 8 with a screw connection. For this purpose, in FIG. 6 the base plate 3 comprises an upwardly projecting collar 21 on which a connecting piece 22 is fastened extending toward the central fastening point B. Alternatively, the base plate 3 and connecting piece 22 can be configured as one component. In general, however, they are separate components since the base plate 3 is made of metal (for example by die casting) and the connecting piece 22 is made of plastic so as not to impair the transmitting and receiving properties of the antenna elements. In the region of the central fastening point B, the intermediate cover 8 and the outer cover 9 are provided with mutually corresponding contact faces 23 and 24 that have a pot or basket shape in this example. These pot shaped contact areas 23 and 24 have the advantage that a screw 25 can be provided as the fastener beneath the surface of the outer cover 9, so that the screw 25 does not interfere with the outward appearance of the roof antenna 1. The screw is screwed into the connecting piece 22 and can be configured, for example, as a self-tapping screw 25 (see FIG. 7). In this illustrated embodiment according to FIG. 6, the outer cover 9 is therefore guided in the region of the central fastening point B, is inserted axially in the direction of the vehicle roof 2 into the contact area 23 of the intermediate cover 8 and the two covers 8 and 9 are detachably connected using the screw 25 so that upon actuation of the screw 25 not only are the two covers 8 and 9 fastened to each other, but also the seal 12 is engaged by the outer lower edge of the outer cover 9, thus achieving the optimal sealing effect of the seal 12 when the contact areas 23 and 24 come into full contact with each other The axial height of the connecting piece 22, which has likewise been selected to achieve optimal sealing effect when the contact area 24 of the outer cover 9 has come into contact with the face of the connecting piece 22, also serves to limit the travel path.

It is essential to all illustrated embodiments that the fastener in the region of the central fastening point B and the geometric extensions of the outer cover 9 are selected such that the optimal effect of the seal 12 is achieved when the fastener is in its end position and the outer cover 9 has assumed the desired position relative to the intermediate cover 8.

### LIST OF REFERENCE NUMERALS

1. Roof Antenna

2. Vehicle Roof

3. Base Plate

4. Circuit Board

5. Antenna Element

6. Antenna Element

7. Antenna Element

8. Intermediate Cover

9. Outer Cover (also referred to as Decor Cover)

10. Screw Connection

11. Clamping Plate

12. Seal

13. Seat

14. Locking Pin

15. Interior Seat

16. Outwardly Directed Catch-Lug

17. Inwardly Directed Catch Lug

18. Sealing Element

19. Tool

20. Gap

21. Collar

22. Connecting Piece

23. Contact Area (of the Intermediate Cover)

24. Contact Area (of the Outer Cover)

25. Screw

B Sole (Single) Fastening Point

1. A roof antenna for installation on the roof of a vehicle, the roof antenna comprising a base plate with at least one antenna element and an outer cover for covering the interior region of the roof antenna covered by an intermediate cover and the base plate being connected to the vehicle roof with fastener, characterized in that in the region of the contact area of the outer lower edge of the outer cover a seal is provided and fastener are provided in a central location, which means detachably or non-detachably fasten the outer cover to the intermediate cover, the sealing effect of the seal being achieved after securing the outer cover to the intermediate cover using the fastener.

2. The roof antenna according to claim 1, characterized in that the intermediate cover comprises an inwardly directed seat and the outer cover comprises an inwardly directed locking pin, the locking pin latching into the seat after insertion when the outer cover has assumed the desired position relative to the intermediate cover and upon actuation of the seal.

3. The roof antenna according to claim 2, characterized in that the seat comprises an inwardly directed catch lug and the locking pin comprises an outwardly directed catch lug that corresponds to the catch lug.

4. The roof antenna according to claim 2, characterized in that the locking pin has a continuous interior seat.

5. The roof antenna according to claim 1, characterized in that the intermediate cover comprises an inwardly directed pot shaped contact area and the outer cover comprises an inwardly directed pot-shaped contact area, the contact area being firmly connected to the contact area after insertion when the outer cover has assumed the desired position relative to the intermediate cover and upon actuation of the seal.

6. The roof antenna according to claim 5, characterized in that the connection is a glue connection.

7. The roof antenna according to claim 6, characterized in that the connection is a screw connection using a screw.

8. The roof antenna according to claim 7, characterized in that an upwardly projecting connecting piece is provided on the base plate or is formed by the base plate, in which the pot-shaped contact areas can be mutually connected on the upper end using the screw.

9. A roof antenna according to claim 1, characterized in that in the region of the central fastening point a seal is mounted between the outer cover and the intermediate cover.

10. A method for disassembling the outer cover of a roof antenna according to claim 1, wherein the steps for installing the outer cover are performed in the reverse order.

11. A method for disassembling the outer cover of a roof antenna according to claim 1, the outer cover provided with a hole, particularly a small oblong hole, in the region of the fastening point B, which either creates the interior seat or makes the interior seat accessible if such a seat is provided, and is inserted through the interior seat when it becomes accessible using a pulling tool, a 90° rotation engaging the tool beneath the wall of the outer cover and allowing the outer cover to be removed against the latching force of the latching means from the roof antenna, particularly the intermediate cover, by pulling the tool.
